(19) United States
(12) Patent Application Publication
(10) Pub. No.: US 2026/0122484 A1
(43) Pub. Date: Apr. 30, 2026

(54) USER EQUIPMENT IDENTITY MANAGEMENT AT ENTRY LEVEL IN TELECOMMUNICATIONS NETWORKS

(71) Applicant: DISH Wireless L.L.C., Englewood, CO (US)

(72) Inventors: Ravi Madhavan, Naperville, IL (US); Ramakrishna Mudumby, Littleon, CO (US); Manvendra Pratap Singh, Highlands Ranch, CO (US)

(21) Appl. No.: 18/926,147

(22) Filed: Oct. 24, 2024

(51) Int. Cl. H04W 12/06; H04W 12/02; H04W 60/00

(52) U.S. Cl. CPC H04W 12/06; H04W 12/02; H04W 60/00

(57) ABSTRACT

Systems and methods of managing network identities and access perform or comprise receiving a registration request at a first network node of the telecommunications network, the registration request including an equipment identifier corresponding to a UE transmitting the registration request; prior to performing an authentication sub-procedure: transmitting a UE identity check request to a second network node of the telecommunications network, the UE identity check request including the equipment identifier, and receiving a UE identity check response from the second network node; and in response to a determination that the UE identity check response indicates that the UE is invalid, rejecting the registration request without performing the authentication sub-procedure.

### BACKGROUND

This disclosure relates to wireless data networks, such as 5G wireless networks. Wireless networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers, and other devices. 5G technologies are capable of supplying much greater bandwidths than previously available technologies.

The discussion above is merely provided for general background information and is not intended to be used as an aid in determining the scope of the claimed subject matter.

### SUMMARY

Various aspects of the present disclosure relate to systems and methods in a telecommunications network to control notification flow to subscribed network functions.

According to one aspect of the present disclosure, a method of managing a user equipment (UE) identity is provided. The method comprises receiving a registration request at a first network node of the telecommunications network, the registration request including an equipment identifier corresponding to a UE transmitting the registration request; prior to performing an authentication sub-procedure: transmitting a UE identity check request to a second network node of the telecommunications network, the UE identity check request including the equipment identifier, and receiving a UE identity check response from the second network node; and in response to a determination that the UE identity check response indicates that the UE is invalid, rejecting the registration request without performing the authentication sub-procedure.

According to another aspect of the present disclosure, a telecommunications network is provided. The network comprises at least one processor in communication with a first network node of the telecommunications network; and a first memory storing instructions that, when executed by the at least one processor, cause the first network node to: receive a registration request, the registration request including an equipment identifier corresponding to a UE transmitting the registration request, prior to performing an authentication sub-procedure: transmit a UE identity check request to a second network node of the telecommunications network, the UE identity check request including the equipment identifier, and receive a UE identity check response from the second network node, and in response to a determination that the UE identity check response indicates that the UE is invalid, reject the registration request without performing the authentication sub-procedure.

According to another aspect of the present disclosure, a non-transitory computer-readable medium is provided. The non-transitory computer-readable medium stores instructions that, when executed by at least one processor of a first network node in a telecommunications network, cause the first network node to perform operations comprising receiving a registration request, the registration request including an equipment identifier corresponding to a UE transmitting the registration request; prior to performing an authentication sub-procedure: transmitting a UE identity check request to a second network node of the telecommunications network, the UE identity check request including the equipment identifier, and receiving a UE identity check response from the second network node; and in response to a determination that the UE identity check response indicates that the UE is invalid, rejecting the registration request without performing the authentication sub-procedure.

### BRIEF DESCRIPTION OF THE DRAWINGS

The following drawings are provided to help illustrate various features of examples of the disclosure and are not intended to limit the scope of the disclosure or exclude alternative implementations.

FIG. 1 illustrates an example of a telecommunications network in accordance with various aspects of the present disclosure.

FIG. 2 illustrates an example of a service-based architecture for a telecommunications network in accordance with various aspects of the present disclosure.

FIG. 3 illustrates an example of a messaging flow for an identity management method according to a comparative example.

FIG. 4 illustrates an example of a messaging flow for an identity management method in accordance with various aspects of the present disclosure.

FIG. 5 illustrates an example of an identity management method in accordance with various aspects of the present disclosure.

FIG. 6 illustrates an example of an identity management system in accordance with various aspects of the present disclosure.

### DETAILED DESCRIPTION

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

The present disclosure is directed to wireless communications networks, also referred to herein as telecommunications networks. The systems and methods set forth herein may be implemented on a telecommunications network in compliance with any telecommunication standard or group of standards; for example, fourth-generation (4G) network standards such as Long Term Evolution (LTE) and/or fifth-generation (5G) network standards such as New Radio (NR). In an example implementation, the wireless communications networks described herein may represent a portion of a wireless network built around 5G standards promulgated by standards setting organizations under the umbrella of the Third Generation Partnership Project (“3GPP”). Accordingly, in some configurations, the wireless communication network may be a 5G network, such as, e.g., a 5G cellular network. Such 5G networks, including the wireless communication networks described herein, may comply with industry standards, such as, e.g., the Open Radio Access Network (Open RAN or O-RAN) standard that describes interactions between the network and user equipment (e.g., mobile phones and the like).

The O-RAN model follows a virtualized model for a cloud-native 5G wireless architecture in which 5G base stations, referred to as next-generation Node Bs (gNBs), are implemented using separate centralized units (CUs), distributed units (DUs), and radio units (RUs). In some configurations, O-RAN CUs and DUs may be implemented using software modules executed by distributed (e.g., cloud) computing hardware. Virtualization allows for various other components of the cellular network, such as cellular network core functions, to be implemented as code that is executed using general-purpose computing resources. Such general-purpose computing resources can be part of a public cloud-computing platform that provides virtual private clouds (VPCs) for multiple clients. On a hybrid cloud cellular network, RAN components of the cellular network are in communication with components of the cellular network executed on a public cloud computing platform, such as Amazon Web Services (AWS).

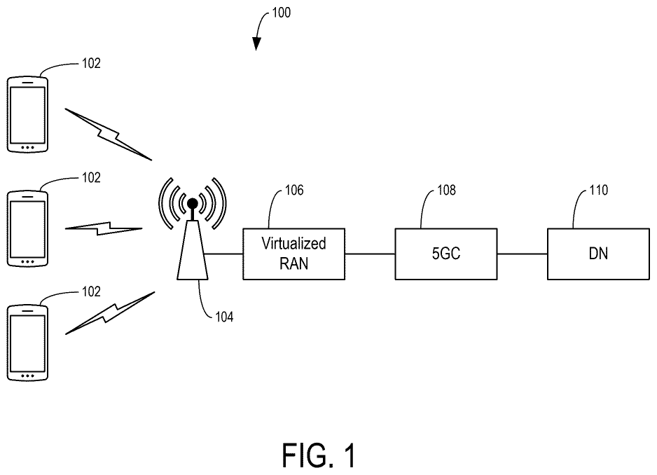

FIG. 1 illustrates an example of a telecommunications network 100 in accordance with various aspects of the present disclosure. In the telecommunications network 100 of FIG. 1, a plurality of UEs 102 are connected to a wireless access point 104, which in turn is connected to a set of virtualized RAN components 106. The virtualized RAN components 106 provide a connection to a 5G core network (5GC) 108, which in turn provides a connection to a data network 110. The wireless access point 104 and the virtualized RAN components 106 may collectively be referred to as a next-generation RAN (NG-RAN).

In some configurations, the telecommunications network 100 may be a standalone (SA) network (e.g., a 5G SA network) that utilizes 5G cells for both signaling and information transfer via a 5G packet core architecture. However, the present disclosure may be implemented with any type of telecommunication network capable of being virtualized.

As used herein, the term “UE” may be one of various types of end-user devices, such as cellular phones, smartphones, cellular modems, cellular-enabled computerized devices, sensor devices, robotic equipment, vehicles, IoT devices, gaming devices, access points (APs), or any computerized device capable of communicating via a cellular network. More generally, a UE 102 can represent any type of device that has an incorporated 5G interface, such as a 5G modem. Examples can include sensor devices, Internet of Things (IoT) devices, manufacturing robots, unmanned aerial (or land-based) vehicles, network-connected vehicles, etc. Depending on the location of individual UEs, a UE 102 may use RF to communicate with various base stations of a telecommunications network. While FIG. 1 illustrates three UEs 102 connected to the wireless access point 104, in practical implementations any number of UEs 102 may be connected to the wireless access point 104 at any given time.

A UE 102 may be associated with one or more equipment identifiers, including permanent identifiers and temporary identifiers. Examples of permanent identifiers include a Subscription Permanent Identifier (SUPI), a Subscription Concealed Identifier (SUCI), an International Mobile Equipment Identity (IMEI), an International Mobile Equipment Identity Software Version (IMEISV), an International Mobile Subscriber Identity (IMSI), a Permanent Equipment Identifier (PEI), and the like. Examples of temporary identifiers include a Globally Unique Temporary Identity (GUTI), a Temporary Mobile Subscriber Identity (TMSI), and the like. Some identifiers, such as the SUCI and GUTI, are privacy-preserving and thus do not expose information that could be used to determine the identity of the equipment or subscriber itself. In some examples, a privacy-preserving identifier may be derived from a non-privacy-preserving identifier, for example by applying an encryption or anonymization algorithm to the non-privacy-preserving identifier. In one particular example, the SUCI may be derived from the SUPI by applying a protection algorithm to the SUPI, thereby to conceal portions of the SUPI that would otherwise identify the UE itself (e.g., to conceal the Mobile Subscriber Identification Number (MSIN) contained in the SUPI).

The wireless access point 104 represents the physical infrastructure (e.g., a 5G tower) to which the UEs 102 connect. The wireless access point 104 may be any structure to which one or more antennas are mounted. The wireless access point 104 may be a dedicated cellular tower, a building, a water tower, or any other man-made or natural structure to which one or more antennas can reasonably be mounted to provide cellular coverage to a geographic area. The wireless access point 104 may include an RU configured to convert radio signals sent to and received from the antenna(s) into a digital signal. The wireless access point 104 is connected to the virtualized RAN components 106 via a fronthaul link over which the digital signals may be communicated. The virtualized RAN components 106 may include a DU connected to a CU via a midhaul link. The CU may be connected to the 5GC 108 via a backhaul link. While FIG. 1 illustrates a single wireless access point 104 and a single set of virtualized RAN components 106, in practical implementations the telecommunications network 100 may include any number of wireless access points 104 and/or any number of virtualized RAN components 106.

In one example, the telecommunications network 100 may be configured according to a region-based network topology. For example, the telecommunications network 100 may be implemented using a cloud computing platform that is logically and physically divided up into various different cloud computing regions (e.g., AWS regions). The cloud computing regions may be based on the geographical location of the gNBs; for example, the telecommunications network 100 for a given nation may be divided into a number of geographical regions. Each of the cloud computing regions can be isolated from other cloud computing regions to help provide fault tolerance, fail-over, load-balancing, and/or stability and each of the cloud computing regions can be composed of multiple availability zones or markets, each of which can be a separate data center located in general proximity to each other (e.g., within 100 miles). For example, one cloud computing region may have its datacenters and hardware located in the northeast of the United States while another cloud computing region may have its data centers and hardware located in California.

Each of the availability zones may be a discrete data center of a group of data centers that allows for redundancy, thereby to provide fail-over protection from other availability zones within the same cloud computing region. For example, if a particular data center of an availability zone experiences an outage, another data center of the availability zone or separate availability zone within the same cloud computing region can continue functioning and providing service. An availability zone may be divided into multiple local zones or areas-of-interest (AOIs). For instance, a client, such as a provider of the telecommunications network 100, can select from more options of the computing resources that can be reserved at an availability zone compared to a local zone. However, a local zone may provide computing resources nearby geographic locations where an availability zone is not available. Each local zone may be divided into multiple gNBs, each of which can serve one or more sites. A site may have one DU and a number of RUs (e.g., six RUs) assigned to it.

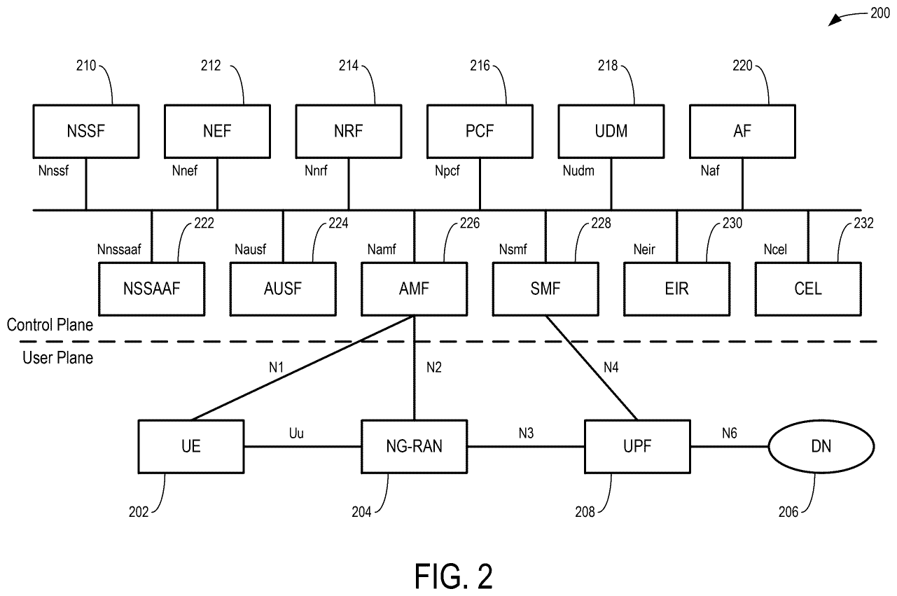

The 5GC 108 provides a plurality of 5G core functions. In the topology of a 5G NR cellular network, 5G core functions of 5GC 108 can logically reside as part of a national data center (NDC). An NDC can be understood as having its functionality existing in a cloud computing region across multiple availability zones. This arrangement allows for load-balancing, redundancy, and fail-over. In local zones, multiple regional data centers can be logically present. Each of regional data centers may execute 5G core functions for a different geographic region or group of RAN components. An example of 5G core components that can be executed within an RDC are described in more detail with regard to FIG. 2. The data network 110 may be the Internet, an enterprise data network, combinations thereof, and the like.

FIG. 2 illustrates an example service-based architecture (SBA) 200 for a telecommunications network (e.g., the telecommunications network 100 of FIG. 1) in accordance with various aspects of the present disclosure. The SBA 200 includes an infrastructure domain, which is divided between a control plane (CP) and a user plane (UP). The CP comprises a plurality of CP network functions (NFs). The UP comprises a UE 202 (e.g., one of the UEs 102 of FIG. 1) connected to an NG-RAN 204, and UP NFs. Using the SBA 200, the UE 202 accesses a data network 206 (e.g., the data network 110 of FIG. 1). For case of illustration, FIG. 2 only shows a single UE 202 being connected to the NG-RAN 204; however, in practical implementations any number of UEs 202 may be present, limited only by the capacity of the network.

The UP NFs include a User Plane Function (UPF) 208. The UPF 208 is a network function that routes and forwards user plane data packets between the base station (cell site; for example, the NG-RAN 204) and the external data network 206 (e.g., the Internet). The UPF 208 is similar to the service and packet gateway functions in a 4G network, but it is cloud-native and can be deployed anywhere to meet service requirements. It can also manage, prioritize, and duplicate data packets as they traverse the network, thus offering redundancy and quality-of-service (QoS) assurance.

The CP NFs include a Network Slice Selection Function (NSSF) 210, a Network Exposure Function (NEF) 212, a Network Repository Function (NRF) 214, a Policy Control Function (PCF) 216, a Unified Data Management (UDM) 218, an Application Function (AF) 220, a Network Slice-specific and SNPN Authentication and Authorization Function (NSSAAF) 222, an Authentication Server Function (AUSF) 224, an Access and Mobility Management Function (AMF) 226, a Session Management Function (SMF) 228, an Equipment Identity Register (EIR) 230, and a Ceased Equipment List (CEL) 232.

The NSSF 210 is a CP function that provides network slices to the AMF 226. A network slice is an independent, end-to-end logical network that runs on shared physical network infrastructure. It involves the allocation of network resources across all network infrastructure to meet specific service requirements, from the network core to the radio access network (RAN). Specific requirements may include QoS assurance, security policies, data isolation, dynamic policy management, etc.

The NEF 212 is a CP function that provides information regarding the network functions that are available to use (by the enterprise customer). It is similar to the 4G Service Capabilities Exposure Function (SCEF), but it is cloud-native and exposes event information, network monitoring, network control, provisioning capabilities, and policy/charging capabilities externally. This allows the enterprise customer to monitor and affect QoS and charging for devices.

The NRF 214 is a CP function that allows 5G network functions to be registered, discovered, and subsequently made available to customers. This is a unique capability in the standalone 5G network that allows customers to subscribe to the necessary microservices or to have dedicated network functions for their services.

The PCF 216 is a CP function that provides policies for mobility and session management. It is similar to the Policy and Charging Rules Function (PCRF) in a 4G network, but it is cloud-native and offers additional capabilities in the 5G network, including event-based policy triggers, resource reservation requests, and access network discovery and selection. The PCF directly influences QoS and subscriber spending limits, and as a result plays a role in the enhanced policy management and control capabilities of the 5G network.

The UDM 218 is a CP function that manages and stores subscriber and device information, default QoS and prioritization, authorized data channels, maximum bit rates, service continuity provisions, and the like. The UDM 218 is similar to the Home Subscriber Server (HSS) function in a 5G network, but it is cloud-native and designed for 5G services.

The AF 220 is a CP function that interacts with the 3GPP Core Network in order to provide services, for example to support one or more of application function influence on traffic routing, application function influence on service function chaining, accessing the NEF 212, interacting with the PCF 216, time synchronization service, IP multimedia subsystem (IMS) interactions with the 5GC, or packet data unit (PDU) set handling.

The NSSAAF 222 is a CP function that supports authentication and authorization of slicing with an AAA server (Authentication, Authorization, and Accounting). It is a unique capability of the standalone 5G network that allows customers to access a predefined network slice or a newly requested network slice in real-time and using their own existing authentication infrastructure.

The AUSF 224 is a CP function that supports authentication for 3GPP access and untrusted non-3GPP access, and authentication of a UE for a disaster roaming service. It can act as an authentication server.

The AMF 226 is a CP function that manages registration, authorization, connection, reachability, and mobility. It is similar to the Mobility Management Entity (MME) function in a 4G network, but it is cloud-native and supports many additional capabilities unique to 5G. For example, it also supports dynamic updating of network interfaces and cellular sites, greater privacy via the use of a 5G temporary device identity, enhanced security across the user and control planes, and stores network slice information. It can also select an appropriate PCF for a device or use case.

The SMF 228 is a CP function that oversees packet data session management, IP address allocation, data tunneling from a cell site base station to the user plane function, and downlink notification management. It performs the tasks of the serving and packet gateways (S-GW & P-GW) in a 4G network, but also allows for control plane and user plane separation in 5G.

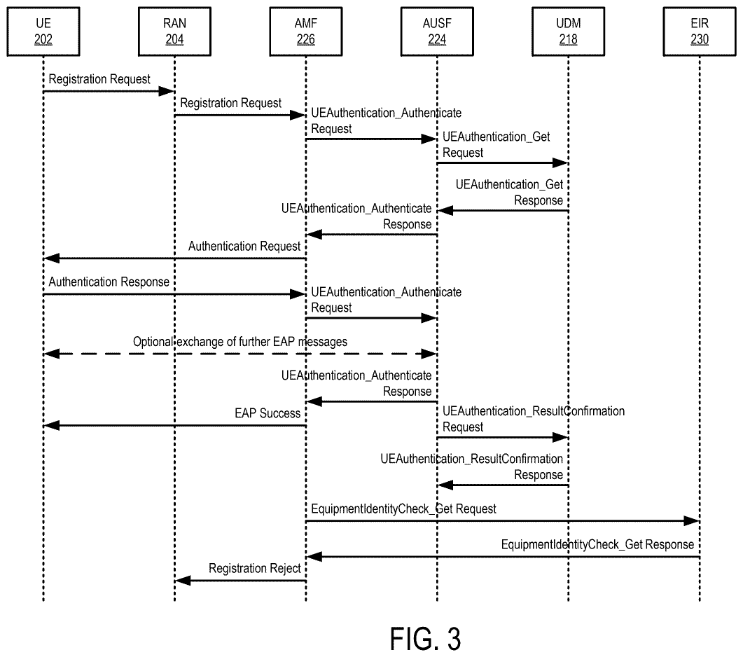

The EIR 230 (sometimes referred to as a “5G-EIR”) is a CP function that provides the ability to check the status of a UE's identity, for example to determine whether the UE has been blacklisted from the network. The services provided by the EIR 230 are consumed by the AMF 226. It may be invoked during any procedure establishing a signaling connection between a UE and the network based on a PEI of the UE. However, the EIR 230 is not invoked at the entry level, but is instead invoked after several connection operations (e.g., authentication and/or security procedures) have been performed involving several other NFs, as will be described in more detail below with regard to FIG. 3. Moreover, the EIR 230 may not operate with other types of identifiers, such as temporary identifiers and/or encrypted identifiers. Additionally, emergency registrations may not be subject to an equipment check, and thus the EIR 230 may not be invoked in such cases.

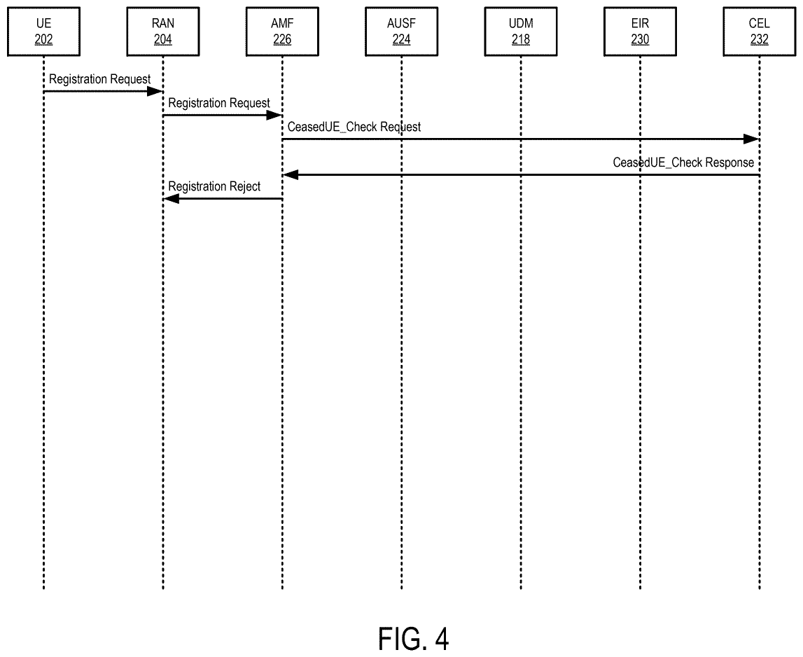

The CEL 232 is a CP function provided to implement the systems and methods of the present disclosure. The CEL 232 addresses, for example, shortcomings of the EIR 230. The CEL 232 may be invoked at the entry level; that is, at or near the beginning of the process of establishing a connection between the UE 202 and the DN 206. The CEL 232 may be used where the UE 202 attempts to access the network through a privacy-preserving identifier, such as a SUCI; through a temporary identifier, such as a TMSI; and/or through a standard identifier, such as a PEI or IMEI. One example of the manner in which the CEL 232 may be invoked is described in more detail below with regard to FIG. 4.

The SBA 200 further includes a plurality of service-based interfaces to provide access to or communication with the various NFs. As illustrated, these include an Nnssf interface for the NSSF 210, an Nnef interface for the NEF 212, an Nnrf interface for the NRF 214, an Npcf for the PCF 216, an Nudm interface for the UDM 218, an Naf interface for the AF 220, an Nnssaaf interface for the NSSAAF 222, an Nausf interface for the AUSF 224, an Namf interface for the AMF 226, an Nsmf interface for the SMF 228, an Neir interface for the EIR 230, and an Ncel interface for the CEL 232. FIG. 1 also illustrates several reference points (i.e., interfaces between two NFs or entities), including an N1 interface between the UE 202 and the AMF 226, a Uu interface between the UE 202 and the NG-RAN 204, an N2 interface between the NG-RAN 204 and the AMF 226, an N3 interface between the NG-RAN 204 and the UPF 208, an N4 interface between the UPF 208 and the SMF 228, and an N6 interface between the UPF 208 and the data network 206. While not illustrated in FIG. 2, the SBA 200 may include a direct interface between the AMF 226 and the CEL 232. Any of the above-described interfaces may be an SBI interface (e.g., an http2 based interface).

The above-listed NFs and interfaces are intended to be illustrative and not exhaustive. In practical implementations, the SBA 200 may include additional NFs or other network entities, such as an Unstructured Data Storage Function (UDSF), a Network Slice Admission Control Function (NSCAF), a Unified Data Repository (UDR), a UE radio Capability Management Function (UCMF), a 5G-Equipment Identity Register (5G-EIR), a Charging Function (CHF), a Time Sensitive Networking AF (TSN AF), a Time Sensitive Communication and Time Synchronization Function (TSCTSF), a Data Collection Coordination Function (DCCF), an Analytics Data Repository Function (ADRF), a Messaging Framework Adaptor Function (MFAF), a Non-Seamless WLAN Offload Function (NSWOF), an Edge Application Server Discovery Function (EASDF), a Service Communication Proxy (SCP), a Security Edge Protection Proxy (SEPP), a Non-3GPP InterWorking Function (N3IWF), a Trusted Non-3GPP Gateway Function (TNGF), a Wireline Access Gateway Function (W-AGF), a Network Data Analytics Function (NWDAF), or a Trusted WLAN Interworking Function (TWIF).

Any of the NFs illustrated in FIG. 2 and/or described above may be implemented as a software unit residing on a server (i.e., in the cloud). Each NF can include multiple pods. A “pod” refers to a software sub-component of the NF. Kubernetes, Docker, or some other container orchestration platform can be used to create and destroy the logical CU or 5G core units and subunits as needed for the data network 110 to function properly. The pods may be deployed on one or more virtual machines configured by a network operator. Kubernetes allows for container deployment, scaling, and management. As an example, if cellular traffic increases substantially in a region, an additional logical CU or components of a CU may be deployed in a data center near where the traffic is occurring without any new hardware being deployed. Instead, processing and storage capabilities of the data center would be devoted to the needed functions. When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers. Thus, the SBA 200 may be implemented on or using one or more computing devices, each of which includes a processor and a memory.

As used herein, a “processor” may include one or more individual electronic processors, each of which may include one or more processing cores, and/or one or more programmable hardware elements. The processor may be or include any type of electronic processing device, including but not limited to central processing units (CPUs), graphics processing units (GPUs), application-specific integrated circuits (ASICs), field-programmable gate arrays (FPGAs), microcontrollers, digital signal processors (DSPs), or other devices capable of executing software instructions. When a device is referred to as “including a processor,” one or all of the individual electronic processors may be external to the device (e.g., to implement cloud or distributed computing). In implementations where a device has multiple processors and/or multiple processing cores, individual operations described herein may be performed by any one or more of the microprocessors or processing cores, in series or parallel, in any combination. In some implementations, one or more of the processing units or processing cores may be remote (e.g., cloud-based).

As used herein, a “memory” may be any storage medium, including a non-volatile medium, e.g., a magnetic media or hard disk, optical storage, or flash memory; a volatile medium, such as system memory, e.g., random access memory (RAM) such as dynamic RAM (DRAM), synchronous dynamic RAM (SDRAM), static RAM (SRAM), extended data out (EDO) DRAM, extreme data rate dynamic (XDR) RAM, double data rate (DDR) SDRAM, etc.; on-chip memory; and/or an installation medium where appropriate, such as software media, e.g., a CD-ROM, or floppy disks, on which programs may be stored and/or data communications may be buffered. The term “memory” may also include other types of memory or combinations thereof. For the avoidance of doubt, cloud storage is contemplated in the definition of memory. A memory is an example of a non-transitory computer-readable medium which stores instructions that are executable by a processor (or processors), the execution of which causes the executing device (e.g., a computer) to perform certain operations, such as those operations described herein.

In the SBA 200 shown in FIG. 2, the NG-RAN 204 may include some or all of the virtualized RAN components 106 illustrated in FIG. 1. Thus, the NG-RAN 204 may include at least one CU, at least one DU configured to operate under the control of one or more of the at least one CU, and at least one RU configured to operate under the control of one or more of the at least one DU. For example, each CU in the NG-RAN 204 may control a plurality of DUs, each of which in turn may control a plurality of RUs. Each RU may be operatively connected to a power amplifier and transmission elements (e.g., antennae) configured to cooperate to transmit signals to connected UEs 202 according to a transmission schedule.

In examples, the SBA 200 may be applicable to a particular cloud computing region. For example, as noted above, one instance of the SBA 200 may exist within a first geographical region (e.g., the northeastern United States) while another instance of the SBA 200 may exist within a second geographical region (e.g., the western United States). In this implementation, the above described NFs may be embodied in the form of computing nodes in data centers located within the corresponding geographical region. Thus, the first instance of the SBA 200 may be implemented by computing nodes in one or more data centers physically located in the northeastern United States, the second instance of the SBA 200 may be implemented by computing nodes in one or more data centers physically located in the western United States, and so on. Within each instance of the SBA 200, the computing nodes may be configured to implement at least instance of each of the above-described NFs.

The NFs operate together to perform and/or manage various procedures within the network, including connection, registration, and mobility management procedures. For example, in order to receive services from the network, a UE must first register with the network (e.g., when initially joining the network, when moving to a new tracking area within the network, and so on). When the UE seeks to register with the network, a series of operations are performed, including the transmission of messages between the various network entities (e.g., between various NFs) of the SBA 200. FIG. 3 illustrates an example of the message flow for a portion of the registration procedure according to a comparative example.

In FIG. 3, the UE 202, the RAN 204, the AMF 226, the AUSF 224, the UDM 218, and the EIR 230 are illustrated for ease of explanation, although it should be noted that additional NFs (e.g., the PCF 216, the SMF 228, a previous instance of the AMF 226, etc.) may be implicated in registration operations not illustrated in FIG. 3, such as registration operations that occur subsequent to those illustrated in FIG. 3.

The registration procedure begins with the UE 202 sending a registration request message to the RAN 204. The registration request may include several parameters, such as an equipment identifier, a radio resource control (RRC) setup request, various items of metadata, and the like. The equipment identifier may be a privacy-preserving identifier, such as a SUCI, which cannot be directly handled by the AMF 226. The RAN 204 may be configured to select the appropriate destination AMF 226 based on information in the registration request. Once the appropriate destination AMF 226 has been selected, the RAN 204 sends an N2 message including the registration request to the AMF 226.

Upon receipt of the registration request from the RAN 204, the AMF 226 may initiate a UE authentication sub-procedure by invoking the AUSF 224. The UE authentication sub-procedure includes the exchange of several messages. To initiate the sub-procedure, the AMF 226 sends a UEAuthentication_Authenticate Request message to the AUSF 224 via the Nausf interface. The UEAuthentication_Authenticate Request message includes the equipment identifier in the form of a SUCI or SUPI, as well as a serving network identifier. The AUSF 224 checks whether the AMF 226 is entitled to use the serving network by comparing the serving network identifier with an expected serving network identifier.

If the AUSF 224 determines that the AMF 226 is so entitled, the AUSF 224 sends a UEAuthentication_Get Request message to the UDM 218 via the Nudm interface, the message including the equipment identifier and the serving network identifier. Based on the equipment identifier, the UDM 218 determines the authentication method. In the example illustrated in FIG. 3, the authentication process is shown for the Extensible Authentication Protocol Authentication and Key Agreement prime (EAP-AKA′) authentication method. The EAP-AKA′ authentication method begins with the UDM 218 generating an authentication vector, computing transformed keys, transforming the authentication vector based on the transformed keys, and transmitting the transformed authentication vector to the AUSF 224 via the Nudm interface in the form of a UEAuthentication_Get Response. The AUSF 224 then sends a UEAuthentication_Authenticate Response to the AMF 226 via the Nausf interface.

The AMF 226 then transparently forwards a message component of the UEAuthentication_Authenticate Response message to the UE 202 via the RAN 204, in the form of a NAS message Authentication Request message. The UE 202 then calculates a response, for example by verifying the freshness of the transformed authentication vector. The UE 202 then sends the response to the AMF 226 via the RAN 204, in the form of a NAS message Authentication Response message. The AMF 226 transparently forwards a message component of the Authentication Response message to the AUSF 224 using the Nausf interface in the form of a UE_Authentication_Authenticate Request message. The AUSF 224 then verifies the message, and only continues if the message is successfully verified. At this point, the AUSF 224 and the UE 202 may exchange additional request and response messages. After the additional message exchange has completed, the AUSF 224 derives additional information from the transformed keys in the transformed authentication vector and transmits a UEAuthentication_Authenticate Response message to the AMF 226 via the Namf interface. The AMF 226 then sends an EAP Success message to the UE 202 via the N1 interface.

It should be noted that, if another type of authentication such as 5G AKA is performed, the message flow will be largely similar except that there may be no optional exchange of further EAP messages, the various calculations and verifications may be different, and the EAP Success message may be omitted. Regardless of the authentication method used, once authentication is completed the AUSF 224 sends a UEAuthentication_ResultConfirmation Request message to the UDM 218 via the Nudm interface, thereby informing the UDM 218 about the result and time of the authentication sub-procedure.

The UDM 218 then stores the authentication status of the UE 202, and subsequently replies to the AUSF 224 with a UEAuthentication_ResultConfirmation Response message via the Nudm interface. Afterward, the UDM 218 may authorize subsequent procedures based on the stored UE authentication status. After all of the above messages have been exchanged and calculations performed, the authentication sub-procedure is completed.

It is only at this point, in the comparative example, that the AMF 226 initiates a UE identity check. This is performed by the AMF 226 sending an EquipmentIdentityCheck_Get Request to the EIR 230 via the Neir interface, and the EIR 230 responding with an EquipmentIdentityCheck_Get Response message via the Neir interface. The EIR 230 checks whether the PEI is in the prohibited list or not. If the PEI is in the prohibited list, the EquipmentIdentityCheck_Get Response may indicate that the PEI is unknown or blacklisted, and the AMF 226 may send a Registration Reject message to the RAN 204. Subsequent registration sub-procedures, such as policy control/setup, subscriptions, PDU session management, and the like (not shown) are performed if the EIR 230 determines that the PEI is not in the prohibited list. As can be seen from FIG. 3, a large number of messages must be exchanged and a large number of calculations must be performed before the EIR 230 is invoked.

In some instances, unauthorized UEs (e.g., rogue UEs or UEs that have been ceased from the network) attempt to connect to the network with a flood of messages. While such unauthorized UEs may eventually be identified and denied access by the EIR 230, the large number of messages and calculations prior to this point may result in a drastic drop in network-wide key performance indicators (KPIs). Manual identification of such devices requires a very large amount of processing resources. Moreover, the long period of time before such devices may be manually identified means that the network KPIs suffer for a long period of time. The comparative examples provide no method to block such DoS attacks. Moreover, malicious entities (e.g., spammers) can use forged equipment identifiers to request an emergency session, which circumvents the EIR 230. In such cases, the malicious identifier will be allocated with a temporary identifier such as a TMSI which can then be used to perform a regular registration. Although these registrations may eventually be rejected by the AMF 226, the registration success rate will drop and network KPIs will suffer.

To address this, the present disclosure sets forth systems and methods that are capable of blocking unauthorized UEs at the entry level (i.e., before the exchange of the large number of messages and the performance of the large number of calculations, as in the comparative example of FIG. 3). This may be accomplished by deploying the CEL 232 as an additional NF. The CEL 232 may be configured at multiple levels, for example to account for different types of equipment identifiers. By invoking the CEL 232 at the entry level, any faulty equipment identifier (e.g., a ceased UE) or malicious entity may be rejected immediately (i.e., before performing authentication and other subsequent procedures), without the processing-intensive operations described above. Moreover, whereas the EIR 230 is only operable with certain types of equipment identifiers, the CEL 232 may be operable with a variety of equipment identifiers, including SUCI, IMEI, IMEISV, PEI, IMSI, SUPI, and GUTI.

FIG. 4 illustrates an example of the message flow for a portion of the registration procedure according to the present disclosure. In FIG. 4, the UE 202, the RAN 204, the AMF 226, the AUSF 224, the UDM 218, the EIR 230, and the CEL 232 are illustrated for ease of explanation. Because FIG. 4 illustrates an example where a registration request is denied, the AUSF 224, the UDM 218, and the EIR 230 are not implicated in the registration procedure. Thus, they are illustrated for case of comparison with the example of FIG. 3. It should be noted that additional NFs (e.g., the PCF 216, the SMF 228, a previous instance of the AMF 226, etc.) may be implicated in registration operations not illustrated in FIG. 4, such as registration operations that occur subsequent to those illustrated in FIG. 4.

As in the comparative example, the registration procedure begins with the UE 202 sending a registration request message to the RAN 204. The registration request may include several parameters, such as an equipment identifier, a RRC setup request, various items of metadata, and the like. The equipment identifier may be a privacy-preserving identifier, such as a SUCI. The RAN 204 may be configured to select the appropriate destination AMF 226 based on information in the registration request. Once the appropriate destination AMF 226 has been selected, the RAN 204 sends an N2 message including the registration request to the AMF 226.

Before invoking the AUSF 224 and/or the UDM 218, the AMF 226 sends a message to the CEL 232 via the Ncel interface, in the form of a CeasedUE_Check Request. The message may include at least the equipment identifier. Upon receiving the message, the CEL 232 checks a database (e.g., an internal database) to identify “block only” cases based on defined criteria. For example, the CEL 232 may check the equipment identifier against a blacklist (i.e., a list of prohibited, ceased, rogue, or otherwise invalid UEs) and/or a whitelist (i.e., a list of permitted, active, or otherwise valid UEs). The CEL 232 responds with a message via the Ncel interface in the form of a CeasedUE_Check Response. If the CEL 232 determines that the UE 202 is valid, the CeasedUE_Check Response may be, for example, a “200 OK” message with the message body indicating that the UE 202 is whitelisted. If the CEL 232 determines that the UE 202 is not valid, the CeasedUE_Check Response may indicate the specific failure case (e.g., the UE 202 is blacklisted, the equipment identifier is unknown, etc.). If the UE 202 is invalid, the AMF 226 in turn sends a Registration Reject message to the RAN 204. If the UE 202 is valid, on the other hand, the network may proceed with subsequent operations of the registration procedure, such as an authentication/security sub-procedure as described above with regard to FIG. 3. As can be seen by comparing FIG. 3 and FIG. 4, the inclusion and use of the CEL 232 significantly reduces the messaging burden, and by extension the processing burden, for invalid UEs.

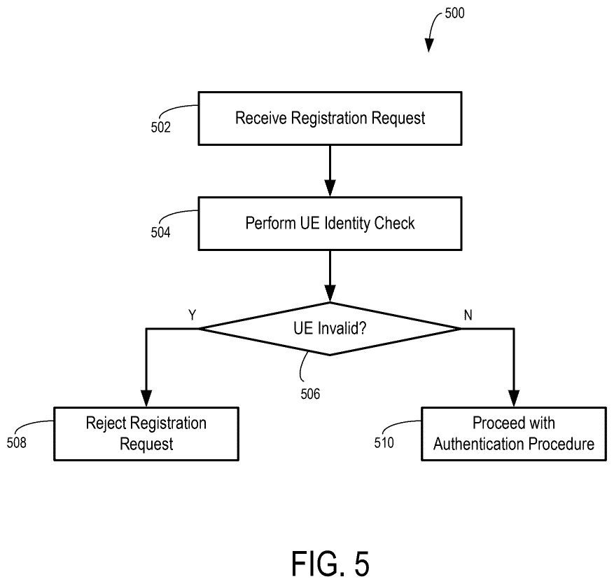

Accordingly, the CEL 232 is configured to implement a method for managing UE identity. FIG. 5 illustrates an example method 500. The method 500 may be implemented by a network node, as will be discussed in more detail below. The network node may be a cloud computing node located at a data center associated with a cloud computing region of a network in accordance with the present disclosure. In an example, the network node may be associated with an AMF of the network (e.g., the AMF 226).

The method 500 begins with operation 502 of receiving a registration request at the network node. The registration request may include an equipment identifier corresponding to a UE transmitting the registration request. In examples, the equipment identifier may be a privacy-preserving identifier, such as a SUCI and/or a GUTI. The equipment identifier may be a temporary identifier, such as a TMSI and/or the GUTI.

At operation 504, a UE identity check is performed. The UE identity check may include transmitting a UE identity check request to a second network node of the network (e.g., a network node associated with a CEL of the network, such as the CEL 232), the UE identity check request including the equipment identifier, and receiving a UE identity check response from the second network node. The UE identity check itself may include checking the equipment identifier against a blacklist in a database, and generating the UE identity check response to include information indicating a result of the checking. The database may be internal to the second network node (i.e., internal to the CEL). As illustrated in FIG. 4 and described above, the UE identity check is performed prior to performing an authentication sub-procedure.

At operation 506, it is determined whether the UE is valid or invalid. For example, the network node associated with the AMF may parse the UE identity check response. If the UE identity check response indicates that the UE is invalid, at operation 508 the registration request is rejected without performing the authentication sub-procedure. If the UE identity check response indicates that the UE is valid, at operation 510 the network node may proceed with the authentication sub-procedure (e.g., by invoking the AUSF and/or UDM as illustrated in FIG. 3 and described above).

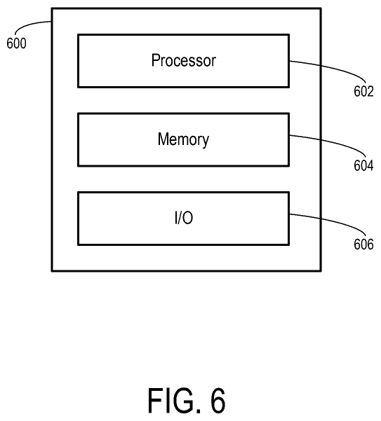

FIG. 6 illustrates one example of an identity management node 600, which is itself an example of a computing node configured to implement the method 500 described above. As illustrated, the identity management node 600 comprises a processor 602, a memory 604, and an input/output (I/O) interface 606. The identity management node 600 may be configured with various modules (e.g., various software modules) to implement identity check functions. In some implementations, the identity management node 600 may correspond to one of the above described network nodes (e.g., a network node associated with one or more NFs). In one example, the identity management node 600 is associated with an AMF of the network. In another example, the identity management node 600 is associated with a CEL of the network.

In one example, the modules may be present in the memory 604 in the form of instructions that, when executed by the processor 602, cause the network management node 600 to perform any one or more of the operations described herein. In another example, the processor 602 may be configured to load and/or execute instructions from another non-transitory computer-readable medium (e.g., cloud storage or from the memory of another device). In some examples, the following modules may be in the form of xApps and/or rApps (or portions or combinations thereof).

The identity management node 600 may comprise a logic module configured to perform various determinations and other logical operations. In the example in which the identity management node 600 is associated with the AMF, the logic module may be configured to generate and/or execute instructions to receive a registration request (e.g., via the I/O interface 606), instructions to transmit a UE identity check request to another network node (e.g., via the I/O interface 606), instructions to receive a UE identity check response (e.g., via the I/O interface 606), instructions to parse the UE identity check response to determine whether the UE is valid or invalid, and/or instructions to reject the registration request without performing further sub-procedures, such as an authentication sub-procedure.

In the example in which the identity management node is associated with the CEL, the logic module may be configured to generate and/or execute instructions to receive the UE identity check request (e.g., from the AMF via the I/O interface 606), instructions to check the equipment identifier against a blacklist in a database, instructions to generate a UE identity check response including information indicating a result of the check, and/or instructions to transmit the UE identity check response (e.g., to the AMF via the I/O interface 606). The database may be internal to the identity management node 600, for example as part of the memory 604.

The I/O interface 606 may include interface components to permit the communication of data to and from external devices or sources. For example, the I/O interface 606 may include communication ports and/or interfaces to permit communication with other computer devices. The communication ports and/or interfaces may permit input and output via wired protocols (e.g., Ethernet, Universal Serial Bus (USB), FireWire, etc.) and/or wireless protocols (e.g., Wi-Fi, Bluetooth, Near Field Communication (NFC), 5G, 4G, etc.). The I/O interface 606 may additionally or alternatively include communication ports and/or interfaces to permit communication with a user. For example, the I/O interface 606 may include interfaces for a mouse, a keyboard, a display, a graphical user interface (GUI), buttons, switches, etc.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed is:

1. A method of managing a user equipment (UE) identity in a telecommunications network, the method comprising:
receiving a registration request at a first network node of the telecommunications network, the registration request including an equipment identifier corresponding to a UE transmitting the registration request;
prior to performing an authentication sub-procedure:
transmitting a UE identity check request to a second network node of the telecommunications network, the UE identity check request including the equipment identifier, and
receiving a UE identity check response from the second network node; and
in response to a determination that the UE identity check response indicates that the UE is invalid, rejecting the registration request without performing the authentication sub-procedure.

2. The method of claim 1, further comprising:
in response to a determination that the UE identity check response indicates that the UE is valid, performing with the authentication sub-procedure.

3. The method of claim 1, further comprising, by the second network node:
checking the equipment identifier against a blacklist in a database; and
generating the UE identity check response to include information indicating a result of the checking.

4. The method of claim 3, wherein the database is internal to the second network node.

5. The method of claim 1, wherein the equipment identifier is a privacy-preserving identifier.

6. The method of claim 1, wherein the equipment identifier is a temporary identifier.

7. The method of claim 1, wherein the first network node is associated with an Access and Mobility Management Function (AMF) of the telecommunications network.

8. A telecommunications network comprising:
at least one processor in communication with a first network node of the telecommunications network; and
a first memory storing instructions that, when executed by the at least one processor, cause the first network node to:
receive a registration request, the registration request including an equipment identifier corresponding to a UE transmitting the registration request,
prior to performing an authentication sub-procedure:
transmit a UE identity check request to a second network node of the telecommunications network, the UE identity check request including the equipment identifier, and
receive a UE identity check response from the second network node, and
in response to a determination that the UE identity check response indicates that the UE is invalid, reject the registration request without performing the authentication sub-procedure.

9. The network of claim 8, wherein the instructions, when executed by the at least one processor, further cause the first network node to:
in response to a determination that the UE identity check response indicates that the UE is valid, perform with the authentication sub-procedure.

10. The network of claim 8, further comprising
at least one additional processor in communication with the second network node; and
a second memory storing instructions that, when executed by the at least one additional processor, cause the second network node to:
check the equipment identifier against a blacklist in a database; and
generate the UE identity check response to include information indicating a result of the checking.

11. The network of claim 10, wherein the database is internal to the second network node.

12. The network of claim 8, wherein the equipment identifier is a privacy-preserving identifier.

13. The network of claim 8, wherein the equipment identifier is a temporary identifier.

14. The network of claim 8, wherein the first network node is associated with an Access and Mobility Management Function (AMF) of the telecommunications network.

15. A non-transitory computer-readable medium storing instructions that, when executed by at least one processor of a first network node in a telecommunications network, cause the first network node to perform operations comprising:
receiving a registration request, the registration request including an equipment identifier corresponding to a UE transmitting the registration request;
prior to performing an authentication sub-procedure:
transmitting a UE identity check request to a second network node of the telecommunications network, the UE identity check request including the equipment identifier, and
receiving a UE identity check response from the second network node; and
in response to a determination that the UE identity check response indicates that the UE is invalid, rejecting the registration request without performing the authentication sub-procedure.

16. The non-transitory computer-readable medium of claim 15, the operations further comprising:
in response to a determination that the UE identity check response indicates that the UE is valid, performing with the authentication sub-procedure.

17. The non-transitory computer-readable medium of claim 15, wherein the UE identity check response includes information indicating a result of checking the equipment identifier against a blacklist in a database.

18. The non-transitory computer-readable medium of claim 15, wherein the equipment identifier is a privacy-preserving identifier.

19. The non-transitory computer-readable medium of claim 15, wherein the equipment identifier is a temporary identifier.

20. The non-transitory computer-readable medium of claim 15, wherein the first network node is associated with an Access and Mobility Management Function (AMF) of the telecommunications network.
